(19) United States
(12) Patent Application Publication
(10) Pub. No.: US 2015/0193881 A1
(43) Pub. Date: Jul. 9, 2015

(54) COMPUTER-IMPLEMENTED METHOD FOR DETERMINING ROOF AGE OF A STRUCTURE

(71) Applicant: BuildFax, Asheville, NC (US)

(72) Inventor: Joseph Tierney Masters Emison, Asheville, NC (US)

(21) Appl. No.: 14/147,266

(22) Filed: Jan. 3, 2014

(51) Int. Cl. G06Q 40/08

(52) U.S. Cl. CPC G06Q 40/08

(57) ABSTRACT

A computer-implemented method for determining roof age of a structure is provided. Such methods comprise receiving data related to a plurality of structures in computer-readable form; converting the computer-readable data into a standardized database format, and based on the converted data, determining a level of roof-enforcement and coverage area for each building department serving the structures; calculating an area average roof age for a plurality of geographical areas of different scope for those structures in the coverage area of building departments passing a roof-enforcement level threshold; and determining roof age for a particular structure based on whether the structure is covered by any of the coverage areas and whether data on roof replacements for the structure is available; wherein the determined roof age may be based on roof replacement data or an area average roof age. The methods are particularly useful in the home owner's insurance industry.

### BACKGROUND OF THE INVENTION

1. Field of the Invention

The present invention relates to determination of roof age for use in the homeowners insurance industry. More particularly, the present invention relates to a computer-implemented method for determining roof age and a roof age confidence score based on information stored in a database of roof-age source information.

2. Description of Related Art

The cost of replacing a roof due to wind, hail, or other weather damage can be significant and depends on the type of materials being replaced. For example, the cost to professionally remove and replace asphalt shingles, the most common type of roofing material, can exceed $8,000 for a typical ranch style home. The cost to replace more expensive materials such as metal, tile, or slate can reach into the tens of thousands of dollars. Further, roof damage is present in 85-95% of wind-related insured property losses each year, according to the Insurance Institute for Business & Home Safety (IBHS), and loses from thunderstorms cost insurers $14.9 billion in 2012, according to the Insurance Information Institute.

As a typical homeowners insurance annual premium is only the fraction of the cost of a roof replacement, replacing a roof can be an expensive proposition for insurance companies. Although damage from wind, rain, and hail are typically covered by insurance policies, many insurance companies are taking steps to mitigate their losses. Because older roofs may be considerably weaker and thus more prone to damage, some insurance companies will not underwrite a policy with roof coverage for a home with a roof age over a certain limit. Also, some companies will only reimburse a depreciated value for a roof if it exceeds a certain age, such as ten years. Further, damage due to normal aging and wear and tear is typically not covered under home insurance policies. Thus, accurate information on the age of a roof at the time an insurance contract is underwritten is of considerable value to insurance companies.

Homeowners insurance companies have traditionally relied on the homeowner to provide roof age information at the time of underwriting. However, homeowner-supplied information on roof age is often based on inaccurate information or misrepresented (since homeowners have an incentive to underestimate roof age), and is not validated by insurance companies. Research by the present inventors has shown that more than two-thirds of all homeowner-supplied roof ages are underestimated by more than five years, and that more than twenty percent are underestimated by more than fifteen years (See Emison and Tachovsky, Homeowner-Supplied Roof Age is Disastrously Wrong, Claim Journal, 2013, http://www.claimsjournal.com/news/national/2013/08/22/235434.htm).

These underestimates can result in significant loses for insurance companies when underwriting or managing a homeowners insurance policy, paying claims, or determining premiums. Thus, there is a need in the insurance industry for more accurate methods for estimating roof age of a property.

### SUMMARY OF THE INVENTION

In one embodiment, a computer-implemented method for determining roof age of a structure is provided, the method comprising one or more or all of receiving data related to a plurality of structures in computer-readable form; converting the computer-readable data into a standardized database format, and based on the converted data determining a level of roof-enforcement and coverage area for each building department serving the structures; calculating an area average roof age for a plurality of geographical areas of different scope for those structures in the coverage area of building departments passing a roof-enforcement level threshold; and determining roof age for a particular structure based on whether the structure is covered by any of the coverage areas and whether data on roof replacements for the structure is available; wherein the determined roof age may be based on roof replacement data or an area average roof age; and wherein one or more of the above steps can be performed through a computer processor.

According to another embodiment, a computer-implemented method for determining roof age of a structure is provided, the method comprising accessing a standardized database of roof age source information; determining a level of roof-enforcement for each area permitted by a building department based on an evaluation of roof source and other information selected from the group consisting of a number of roof permits issued by the building department, the total number of permits issued by the building department, and the population and number of structures for the area permitted by the building department; calculating a geographical footprint of a coverage area for each building department based upon roof age source information including information within building permits supplied by the building department, wherein the information within building permits supplied by the building department comprises geospatial coordinates of structures that were within building permits supplied by the building department, streets within the supplied building permits, and a census tract and block groups within the supplied building permits; calculating an area average roof age for a plurality of geographical areas of different scope for those structures in the coverage area of building departments passing a roof-enforcement level threshold, wherein the area average roof age is calculated based on the weighted average of the average age of set of new properties and the average age of a set of older properties; and determining roof age for a particular structure, wherein if structure-level information on roof replacements is available, the roof age is based upon the date of the most recent roof replacement; if a structure-level information on roof replacements is not available, but is within the coverage area, then the roof age is a range comprising the age of the structure and the first date for which data is available within the coverage area; if the structure is not within the coverage area, then the roof age is an area average roof age for the smallest area that both contains the address of the structure for which the area average roof age is available.

According to another embodiment, a computer-readable medium is provided that includes instructions that, when executed on a computer, cause a computer to receive data related to a plurality of structures in computer-readable form; convert the computer-readable data into a standardized database format, and based on the converted data: determine a level of roof-enforcement and coverage area for each building department serving the structures; calculate an area average roof age for a plurality of geographical areas of different scope for those structures in the coverage area of building departments passing a roof-enforcement level threshold; and determine roof age for a particular structure based on whether the structure is covered by any of the coverage areas and whether data on roof replacements for the structure is available; wherein the determined roof age may be based on roof replacement data or an area average roof age.

According to another embodiment, a computer-readable medium is provided that includes instructions that, when executed on a computer, cause a computer to: access a standardized database of roof age source information; determine a level of roof-enforcement for each area permitted by a building department based on an evaluation of roof source and other information selected from the group consisting of a number of roof permits issued by the building department, the total number of permits issued by the building department, and the population and number of structures for the area permitted by the building department; calculate a geographical footprint of a coverage area for each building department based upon roof age source information including information within building permits supplied by the building department, wherein the information within building permits supplied by the building department comprises geospatial coordinates of structures that were within building permits supplied by the building department, streets within the supplied building permits, and a census tract and block groups within the supplied building permits; calculate an area average roof age for a plurality of geographical areas of different scope for those structures in the coverage area of building departments passing a roof-enforcement level threshold, wherein the area average roof age is calculated based on the weighted average of the average age of set of new properties and the average age of a set of older properties; and determine roof age for a particular structure, wherein: if structure-level information on roof replacements is available, the roof age is based upon the date of the most recent roof replacement; if a structure-level information on roof replacements is not available, but is within the coverage area, then the roof age is a range comprising the age of the structure and the first date for which data is available within the coverage area; if the structure is not within the coverage area, then the roof age is an area average roof age for the smallest area that contains the address of the structure for which the area average roof age is available.

According to another embodiment, a method of obtaining a roof age for a structure is provided, the method comprising accessing a computer comprising at least one processor; a form of computer-readable memory; and a set of computer-executable instructions configured to receive data related to a plurality of structures in computer-readable form; convert the computer-readable data into a standardized database format, and based on the converted data determine a level of roof-enforcement and coverage area for each building department serving the structures; calculate an area average roof age for a plurality of geographical areas of different scope for those structures in the coverage area of building departments passing a roof-enforcement level threshold; and determine roof age for a particular structure based on whether the structure is covered by any of the coverage areas and whether data on roof replacements for the structure is available; wherein the determined roof age may be based on roof replacement data or an area average roof age. The method further comprises providing the address of a structure as input to the computer and receiving roof age as an output; wherein the computer is accessed remotely through a network.

According to any embodiment of the invention, the data related to a plurality of structures may be in a format selected from the group consisting of delimited text format, non-delimited text format, portable document format, word processing document format, database backup format, and spreadsheet format.

According to any embodiment of the invention, the data related to a plurality of structures may be roof-age source information.

According to any embodiment of the invention, the roof-age source information may include structure-level information on building permits, roof permits, inspections, roof warranties, and roof material deliveries.

According to any embodiment of the invention, the data related to a plurality of structures may be obtained from census, county tax assessors, state building departments, insurance departments, roofing materials manufacturers, and roofing materials resellers.

According to any embodiment of the invention, the data related to a plurality of structures may be obtained through an open records request.

According to any embodiment of the invention, converting the computer-readable data into a standardized database format may comprise preparing and modifying a data file so that it can be loaded into a database; loading an output of the preparation into a database; normalizing the content and structure of the data in the database so that it fits preconditions to map; mapping the content in the database to a standardized database layout; and importing by applying the mapping through an automated process to get the content into a standardized database format.

According to any embodiment of the invention, the level of roof enforcement may be determined based on the number of roof permits in the building permit information as compared with a total number of overall permits, population, and number of structures for each building department.

According to any embodiment of the invention, for each building department and range of dates, the level of roof enforcement may be a category selected from the group consisting of Seldom/None, Average, Above Average, and Well Above Average.

According to any embodiment of the invention, determining a coverage area may comprise calculation of a geographical footprint for each building department based upon information within building permits supplied by the building department.

According to any embodiment of the invention, the information within building permits supplied by the building department may comprise geospatial coordinates of structures that were within building permits supplied by the building department, streets within the supplied building permits, and a census tract and block groups within the supplied building permits.

According to any embodiment of the invention, area average roof age may be calculated based on tax assessor data, roof enforcement data, coverage area, and property-level roof replacement data as inputs.

According to any embodiment of the invention, the area average roof age may be calculated for geographic areas selected from the group consisting of zip5 code, city, county, zip3 code, Metropolitan Statistical Area, and state.

According to any embodiment of the invention, an area average roof age may be calculated based on a set of structures in the coverage area of building departments where the enforcement is at least Average.

According to any embodiment of the invention, an area average roof age may be calculated based on a set of structures built shortly before the building permit data coverage starts through present.

According to any embodiment of the invention, the average roof age of the set of structures built shortly before the building permit data coverage starts through present may be calculated and may be termed NewerPropertiesAverageRoofAge.

According to any embodiment, a set of structures that were built significantly prior to the building permit data coverage time frame may be determined.

According to any embodiment of the invention, the NewerPropertiesAverageRoofAge may be applied to the set of structures that were built significantly prior to the building permit data coverage time frame, but modified to their respective structure ages to determine OlderPropertiesAverageRoofAge.

According to any embodiment of the invention, the average roof age for any given area may be calculated by the weighted average of OlderPropertiesAverageRoofAge and NewPropertiesAverageRoofAge for a given area.

According to any embodiment of the invention, if structure-level information on roof replacements is available, the roof age may be based upon the date of the most recent roof replacement.

According to any embodiment of the invention, if a structure-level information on roof replacements is not available, but is within the coverage area, then the roof age may be a range comprising the age of the structure and the first date for which data on a replacement is available within the coverage area.

According to any embodiment, if the property is not within the coverage area, then the roof age may be an area average roof age for the smallest area that contains the address of the structure for which the area average roof age is available.

According to any embodiment of the invention, roof age confidence may be determined in addition to roof age.

According to any embodiment of the invention, if the structure is within a coverage area, then the roof age confidence may be scored as “modeled”

According to any embodiment of the invention, if the structure is within a coverage area and structure-level information on a roof replacement is available, then the roof age confidence may be scored as “high”.

According to any embodiment of the invention, if the structure is within a coverage area but property-level information on a roof replacement is not available, then roof age confidence may be scored as high if the roof enforcement is “above average” or “well above average”, “medium” if the roof enforcement is “average”, or “low” if the roof enforcement is “seldom/none”.

According to any embodiment of the invention, an audit may be performed to verify that the imported data is equivalent to the provided data.

According to any embodiment, roof replacements may be identified in the data or roof age source information through computer-implemented text mining.

Various aspects of these embodiments and other embodiments will be set forth in the drawings and detailed description.

### BRIEF DESCRIPTION OF THE DRAWINGS

The accompanying drawings illustrate certain aspects of embodiments of the invention and should not be used to limit or define the invention. Together with the written description the drawings serve to explain certain principles of the invention.

FIG. 1 is a flowchart illustrating an exemplary embodiment of a computer-implemented method of the invention.

FIG. 2 is a screenshot illustrating an embodiment of a formatted XML output of the computer-implemented method of the invention.

FIGS. 3A-3B are screenshots illustrating an embodiment of a formatted HTML output of the computer-implemented method of the invention.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

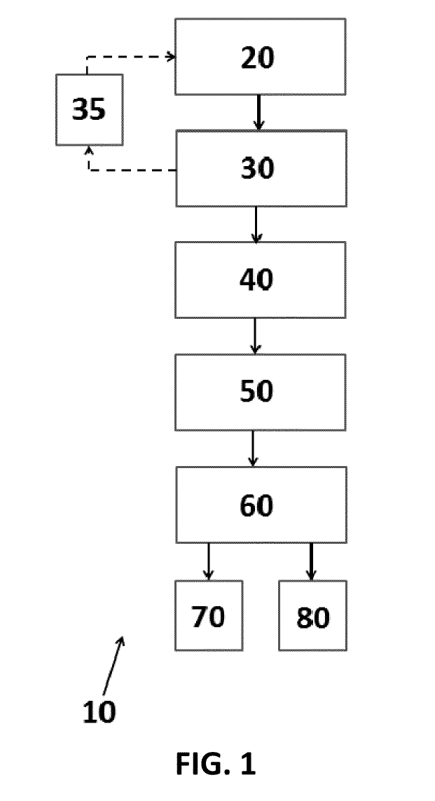

FIG. 1 shows an exemplary embodiment of a computer-implemented method 10 of the present invention. Roof age data and related information is first obtained 20, and then the obtained data is converted to a database 30. A selection of the data in the database may then be audited 35 by comparing to the source data 20. After the data is converted into a standardized database 30, it may be analyzed to determine roof enforcement categorization 40, coverage area 50, and area average roof age 60, and based on these, may then calculate roof age 70 and rook age confidence 80. These steps will be elaborated further below. While an exemplary embodiment arranges these steps as shown in FIG. 1, it will be understood that other variations such as a different order or steps, or elimination, substitution, or addition of steps, may fall within the scope of the invention.

Obtaining Roof Age Information (20)

The computer-implemented method of the present invention, in embodiments, comprises obtaining roof age information and supporting information from a variety of sources. Sources of roof age information and supporting information include Census, County Tax Assessors and state Building Departments, as well as any other government agencies that will supply roof age information through a public records request. For example, some stage agencies (e.g., Texas Department of Insurance) have information on inspections of newly-replaced roofs, and usually supply files under a state open records request. Additional sources include roofing materials manufacturers, which have warranty information on roofs and roofing materials resellers which have delivery information on materials delivered to replace/install roofs; such warranty and delivery information may be available for license. However, these are just examples; the roof age information and supporting information may come from any suitable source.

Information for determining the roof age of residential and non-residential structures can be obtained from these sources through streamlined processes. The information may be obtained in a variety of electronic file formats, including delimited text files [CSVs], non-delimited text files, PDFs, word processing documents [Word], database backup files [Oracle, SQL Server], spreadsheet files [Excel]). The electronic file may be any electronic file suitable for storing data.

The computer-implemented method of the invention, in embodiments, further includes identification of roof replacements within the building permit data through the use of sophisticated text-mining analyses (to identify “roof replacement” but not “rooftop unit”). Text mining analyses may be prepared through Optical Character Recognition methods that convert typed texted into computer-readable text. The text mining analysis may use any of information retrieval, lexical analysis to study word frequency distributions, pattern recognition, tagging/annotation, information extraction, natural language processing, and data mining to perform the analysis.

In embodiments, SOLR (a Lucene-based software package; http://lucene.apache.org/solr/) may be used for text-mining analysis. Exemplary methods of text-mining analysis may include developing a comprehensive set of key words that are present in building permit text that would be indicators of the type of work to be permitted (e.g., “roof”, “rf”, “shingle”) based on input from experts in the construction industry. From the identified key words, a text-mining query can be created, and permits identified that contain the key words or combinations of the key words. From the results of permits matching the query, various permits can be randomly selected. The selected permits may then be audited to identify ways of modifying the queries to limit false positives. The queries can then be revised and the steps repeated until an acceptable false positive rate is reached.

In embodiments, the computer-implemented method may also acquire the property-level information on roof replacements from sources such as roof permits, inspections, roof warranties, and roof material deliveries and store the information in a large database of properties of dates of most-recent-roof-replacement on those properties.

Conversion to Standardized Database (30)

In embodiments of the computer-implemented method of the present invention, a variety of file formats (e.g., CSVs, PDFs, database backups) with different data layouts (e.g., tables and columns) can be used as input, and converted to a single, standardized relational-database-layout output as output. After the step of obtaining roof age information is obtained, the following steps are performed: preparation, loading, normalizing, mapping, and importing, as described below:
Preparation: take the file and make modifications to it so that it can be loaded into a database
Loading: load the output of prep into a database
Normalizing: modify the content and structure of the data in the database so that it fits preconditions to map. This includes organizing the fields and tables to minimize redundancy and dependency.
Mapping: map the content in the database (which is now in an arbitrary database layout) to a standardized database layout. The mapping may be performed in a variety of ways such as through the use of procedural code, creation of XSLT transforms or by using graphical mapping tools.
Importing: apply the mapping through an automated process to get the content into a standardized database layout.

The above processes can be performed by fixing corrupted and misaligned data, with streamlined user interfaces with minimal user input. As a result, the present method of conversion can process thousands of imperfect data files of permit data in a fraction of the time and cost that traditional Extract, Transform, and Load (ETL) software can perform. The present method of conversion can be performed by a person with average computer skills with a web browser.

Audit (35)

In an embodiment, the computer-implemented method of the invention optionally includes an audit to verify that the data out of import is substantially the same as what the source of the information provides, based upon automated internal checks and a manual review of the single-address open-records requests. For example, after an import is run, addresses within the original data submission may be randomly selected and single-address open-records requests for those to audit may be made.

Roof Enforcement Categorization (40)

Once the data is imported into the database, it is analyzed. In embodiments, roof age data such as building department permit data and census and tax assessor data are used to model/estimate roofing permit activity for each jurisdiction (area permitted by a building department), based upon the concept that some building departments will be enforcing the roof code such as through inspections to identify unpermitted work and some building departments will not be. In an exemplary embodiment, enforcement activity is identified by examining the number of roof permits in the building permit data as compared with the total number of overall permits, the local population, and the local number of structures.

From this analysis, for every building department and range of dates, an exemplary embodiment of the computer-implemented method of the present invention generates a local “roof enforcement” categorization:
Seldom/None
Average
Above Average
Well Above Average

The local roof enforcement categorization can be performed in any manner to achieve a set of enforcement categories appropriate for a particular situation. One example can include evaluating the level of roof enforcement for any geographical jurisdiction, such as Brownsville, Tex. If in this jurisdiction, the data indicates that 7% of all permits are roof permits and there are 80 roof permits per 10,000 population per year and 26 roof permits per 1,000 housing units, then for example this jurisdiction may be categorized as Average Enforcement. Any one or more of these factors can be used in any combination to create a set of enforcement levels for a particular situation. The values and numbers provided are merely for illustrative purposes and any appropriate value can be used for a particular threshold.

Further, for example, and in contrast to Brownsville, Tex., if the data indicates that in Santa Rosa, Calif., 19% of all permits are roof permits and there are 281 roof permits per 10,000 population per year and 708 roof permits per 1,000 housing units, then this jurisdiction may be categorized as having a level of enforcement that is higher than that of Brownsville, Tex., or for example as Above Average Enforcement.

In an embodiment, for example, 0-10 roof permits per 1,000 housing units may be considered Seldom/None, 11-100 roof permits per 1,000 housing units may be considered Average, 101-800 roof permits per 1,000 housing units may be considered Above Average, and over 800 roof permits per housing units may be considered Well Above Average. This factor can be the only factor in the analysis or combined with one or more of the factors mentioned above. There may be other factors that can be considered in the analysis as well. The examples and embodiments are provided merely as illustrative, and other ranges for these categories are also possible.

Coverage Area (50)

In an exemplary embodiment, the computer-implemented method of the invention includes calculation of a geographical footprint of the “Coverage Area” for each building department based upon the geospatial coordinates of the properties that were within the supplied building permits, the streets within the supplied building permits, and/or the census tract and block groups within the supplied building permits.

Area Average Roof Age (60)

In an exemplary embodiment, the present computer-implemented method uses tax assessor data (which contains a large list of properties and the years in which they were built), roof enforcement data, Coverage Area calculations, and the property-level roof replacement data as inputs to calculate an area average roof age for different geographical areas (e.g., zip5, city, county, zip3, Metropolitan Statistical Area (MSA), and state). Steps in this process, in embodiments, may include but not be limited to the following:
Properties are limited to those in the Coverage Area of building departments where the enforcement is at least Average.
All properties built shortly before the building permit data coverage starts through today are included, and the building permit data is assumed to contain all roof updates for those properties. In an embodiment, all properties built 10-15 years before the building permit data coverage starts through today are included, based on the jurisdiction which the property is in.
The average roof age of that set of properties is calculated and is termed NewerPropertiesAverageRoofAge.
The proportion of structures that were built significantly prior (e.g., 10-15 years, based on the jurisdiction) to the building permit data coverage time frame is calculated, and the NewerPropertiesAverageRoofAge is applied to them, but modified to their respective structure ages. This operation is calculated as OlderPropertiesAverageRoofAge.
The average roof age for any given area is calculated by the weighted average of OlderPropertiesAverageRoofAge and NewPropertiesAverageRoofAge for the area.

An exemplary roof age calculation may be performed as follows: (a) if data from Jan. 1, 2000 forward for a particular jurisdiction is available; (b) homes built in the jurisdiction from 1985 forward *with* roof updates in the data are identified; and (c) the average roof age of properties with roof updates in the data OR without permitted updates but built after Jan. 1, 2000 is calculated:

For example, if the entire set of data in such an example was 100 properties built in the year 1950 that had roof updates in the year 2000, and 50 properties built in the year 2005 without updates, then the average roof age of this jurisdiction would be about 12 years old, i.e., [100*(2014−2000)+50*(2014−2005)]/150.

Then, (d) a weighted average of (b) and (c) (weighted by the number of properties that fall into both categories) is calculated.

The computer-implemented method of the invention may return a Roof Age and Confidence score for every address in the 50 United States and the District of Columbia as follows:

Roof Age (70):
If property-level information on roof replacements is available, the age is based upon the date of the most recent roof replacement.
If a property-level roof update is not available, but is within the Coverage Area, then a “ranged” roof age is returned, which is between the age of the structure and the first date for which roof replacement data is available within the Coverage Area
If the property is not within the Coverage Area, then the “Area Average Roof Age” for the smallest area that both contains the submitted address and for which the “Area Average Roof Age” is available is returned.

Roof Age Confidence (80):
If the property is within the Coverage Area, then the Roof Age Confidence is scored as “Modeled.”
If the property is within the Coverage Area and property-level information on a roof replacement is available, then the Roof Age Confidence is scored as “High.”
If the property is within the Coverage Area but property-level information on a roof replacement is not available, then Roof Age Confidence is scored as:
   “High” if “roof enforcement” is Above Average or Well Above Average
   “Medium” if “roof enforcement” is Average
   “Low” if the “roof enforcement is Seldom/None

Computer-Executable Instructions

It will be understood that the various methods, processes, and operations of the present invention described and/or depicted herein may be carried out by a group of computer-executable instructions that may be organized into routines, subroutines, procedures, objects, methods, functions, or any other organization of computer-executable instructions that is known or becomes known to a skilled artisan in light of this disclosure, where the computer-executable instructions are configured to direct a computer or other data processing device such as a processor to perform one or more of the specified processes and operations. The computer-executable instructions may be written in any suitable programming language.

Computer-Readable Medium

Embodiments of the invention also include a computer readable medium comprising one or more computer files comprising a set of computer-executable instructions for performing one or more of the calculations, steps, processes and operations described and/or depicted herein. In exemplary embodiments, the files may be stored contiguously or non-contiguously on the computer-readable medium. Embodiments may include a computer program product comprising the computer files, either in the form of the computer-readable medium comprising the computer files and, optionally, made available to a consumer through packaging, or alternatively made available to a consumer through electronic distribution. As used in the context of this specification, a “computer-readable medium” includes any kind of computer memory such as floppy disks, conventional hard disks, CD-ROM, Flash ROM, non-volatile ROM, electrically erasable programmable read-only memory (EEPROM), and RAM. In exemplary embodiments, the computer readable medium has a set of instructions stored thereon which, when executed by a processor, cause the processor to calculate Roof Age and Roof Age Confidence based on data stored in the database described herein. The processor may implement this process through any of the procedures discussed in this disclosure or through any equivalent procedure.

In other embodiments of the invention, files comprising the set of computer-executable instructions may be stored in computer-readable memory on a single computer or distributed across multiple computers. A skilled artisan will further appreciate, in light of this disclosure, how the invention can be implemented, in addition to software, using hardware or firmware. As such, as used herein, the operations of the invention can be implemented in a system comprising any combination of software, hardware, or firmware.

Computers or Devices

Embodiments of the invention include one or more computers or devices loaded with a set of the computer-executable instructions described herein. The computers or devices may be a general purpose computer, a special-purpose computer, or other programmable data processing apparatus to produce a particular machine, such that the one or more computers or devices are instructed and configured to carry out the calculations, processes, steps, and operations of the invention. The computer or device performing the specified calculations, processes, steps, and operations may comprise at least one processing element such as a central processing unit (i.e. processor) and a form of computer-readable memory which may include random-access memory (RAM) or read-only memory (ROM). The computer-executable instructions can be embedded in computer hardware or stored in the computer-readable memory such that the computer or device may be directed to perform one or more of the processes and operations depicted and/or described herein.

Computers Systems

Additional embodiments of the invention comprise a computer system for carrying out the computer-implemented method of the invention. The computer system may comprise a processor for executing the computer-executable instructions, one or more databases described herein, a user interface, and a set of instructions (e.g. software) for carrying out the method. The computer system can be a stand-alone computer, such as a desktop computer, a portable computer, such as a tablet, laptop, PDA, or smartphone, or a set of computers connected through a network including a client-server configuration and one or more database servers. The network may use any suitable network protocol, including IP, UDP, or ICMP, and may be any suitable wired or wireless network including any local area network, wide area network, Internet network, telecommunications network, Wi-Fi enabled network, or Bluetooth enabled network. In one embodiment, the computer system comprises a central computer connected to the internet that has the computer-executable instructions stored in memory that is operably connected to an internal database. The central computer may perform the computer-implemented method based on input and commands received from remote computers through the internet.

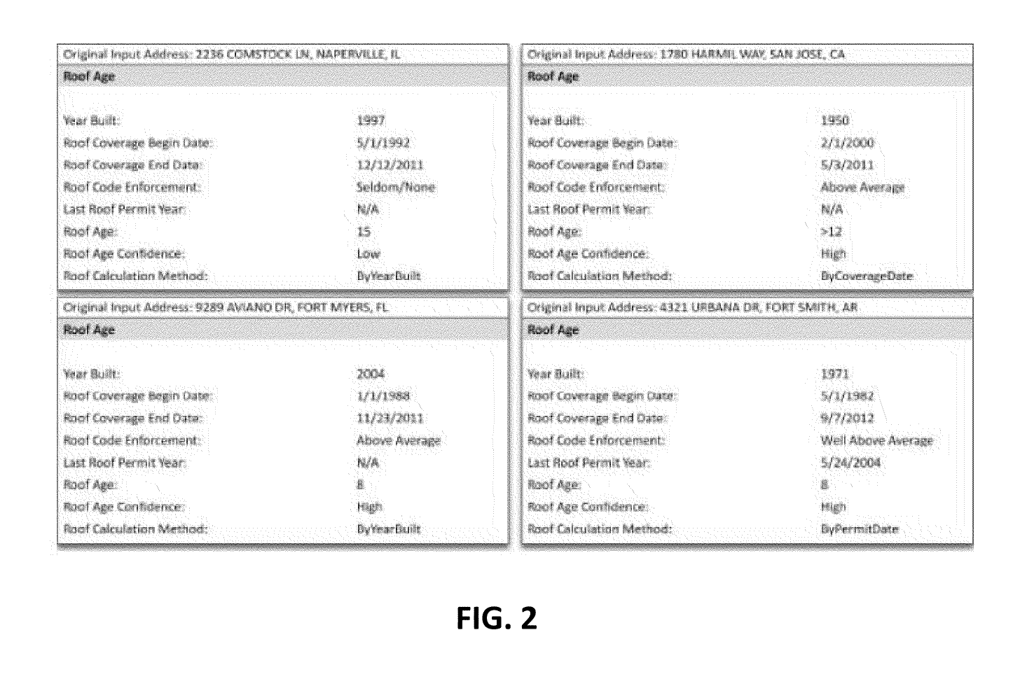

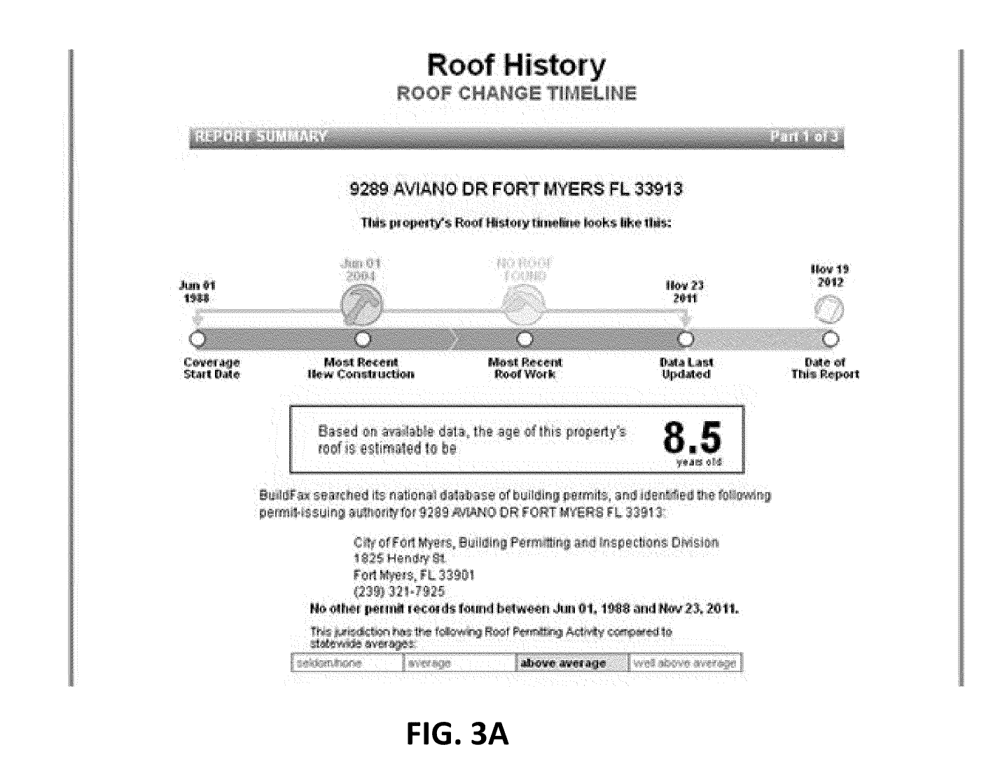

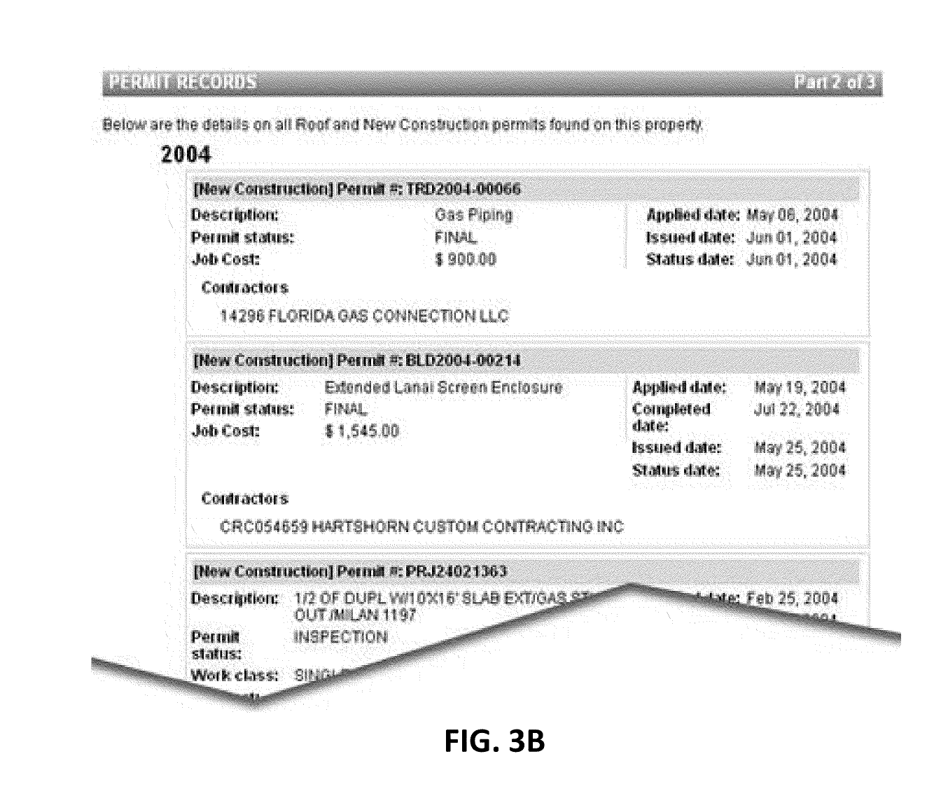

The user interface may be a graphical user interface which may be used in conjunction with the computer-executable code and databases. For example, the graphical user interface may allow a user to input a property address, perform a search for the property in the database, calculate Roof Enforcement, Roof Age, And Roof Age Confidence for the property, and display these and other results of the computer-implemented method of the invention in a variety of report formats such as in formatted XML as shown in FIG. 2 or formatted HTML as shown in FIGS. 3A and 3B, or save a PDF file or print a hardcopy of the results. The graphical user interface may allow a user to perform these tasks through the use of text fields, check boxes, pull-downs, command buttons, and the like. The interface may provide access to information in internal databases or include links to external databases. A skilled artisan will appreciate how such graphical features may be implemented for performing the tasks of the invention. The user interface may optionally be accessible through a computer connected to the internet. In one embodiment, the user interface is accessible by typing in an internet address through a web browser and logging into a web page. The user interface may then be operated through a remote computer accessing the web page.

Such graphical controls and components are reusable class files that are delivered with a programming language. For example, pull-down menus may be implemented in an object-oriented programming language wherein the menu and its options can be defined with program code. Further, some programming languages integrated development environments (IDEs) provide for a menu designer, a graphical tool that allows programmers to develop their own menus and menu options. The menu designers provide a series of statements behind the scenes that a programmer could have created on their own. The menu options may then be associated with an event handler code that ties the option to specific functions. Text fields, check boxes, and command buttons may be implemented similarly through the use of code or graphical tools. A skilled artisan can appreciate that the design of such graphical controls and components is routine in the art.

Applications

The Roof Age and Confidence scores that the computer-implemented method of the present invention calculates are useful in the following ways:

Underwriting—Renewals

For insurance carriers which offer different products and rates based upon roof age (e.g., some products or endorsements require that the customer have a roof under a certain age; other products have discounts/surcharges/rates based upon roof age), getting an accurate roof age as part of the renewal process can significantly improve their business. For example, carriers may just use the High and Medium confidence roof ages, unless they are going to consult individually (on the phone or in person) with the insured, in which case they may use all of the confidence levels.

Claims

If a roof needs to be replaced, almost all insurance companies will pay out the depreciated amount of the roof up front, and then, if a customer has “replacement-cost coverage”, the carrier will pay out the rest of what it cost to replace the roof after the roof is fully replaced (and if the customer has “replacement-cost coverage”, they only get the depreciated amount). Because of this, having an accurate roof age means more accurate depreciation, which is of considerable value to insurance carriers.

Marketing Leads

Carriers may use High confidence Roof Ages that are low (usually <=6 years old) to target structures with new roofs with offers for insurance, usually with a discount because of the newer roof.

Underwriting—New Business

The alternative to Roof Age is for the carrier to ask the insured and the agent to decide together what the roof age of the structure is. This ends up with significantly under-estimated roof age, so obtaining Roof Age as a calculation from the computer-implemented method of the invention is very valuable. The following is an Example of how Roof Age can be used by an insurance company.

Example

An Insurance Agent accesses a webpage with a graphical user interface of the invention and enters the address of the structure in an input form, and the computer-implemented method of the invention returns the Roof Age (but not the Confidence) to the Agent. The Agent and Insured then decide to accept that Roof Age as correct, or to change it, and then they submit that to the carrier.

If the Agent and Insured do not change the Roof Age, or the Confidence was Low or Modeled (which the carrier can see, but the Agent/Insured could not), or the change to the roof age is small, then the carrier will accept the submitted Roof Age.

If the Agent and Insured change the Roof Age, and the Roof Age had High or Medium confidence, and the change to the Roof Age is significant, then the carrier may reject the submitted roof age unless the Insured provides additional documentation supporting the changed Roof Age.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. Embodiments “comprising,” “having,” or “including” various features may alternatively “consist of” or “consist essentially of” any one or more of those features or may include additional features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A computer-implemented method for estimating roof age of a structure, the method comprising:
identifying a target structure for which an estimated roof age is desired;
receiving data related to a plurality of structures in computer-readable form;
converting the data into a standardized database format;
analyzing the data to determine one or more coverage areas of one or more building departments serving one or more of the plurality of structures;
analyzing the data to determine if the target structure is located within the one or more coverage areas;
optionally analyzing the data to determine a level of roof enforcement by the one or more building departments for the one or more coverage areas; and
estimating roof age of the target structure as an age ranging between the age of the target structure and an age calculated from the earliest date of any data in that coverage area, if the target structure is located in one of the coverage areas; or
estimating roof age of the target structure as an area average roof age (i) for the smallest area in which the target structure is located and (ii) for which an area average roof age is available, if the target structure is not located in one of the coverage areas.

2. The method of claim 1, wherein the data is in a format selected from the group consisting of delimited text format, non-delimited text format, portable document format, word processing document format, database backup format, and spreadsheet format.

3. The method of claim 1, wherein the data is roof-age source information selected from one or more of building permits, roof permits, inspections, roof warranties, or roof material deliveries.

4. The method of claim 1, wherein the data is obtained from census, county tax assessors, state building departments, insurance departments, roofing materials manufacturers, or roofing materials resellers.

5. The method of claim 1, wherein the converting of the computer-readable data into a standardized database format comprises one or more of:
preparation of a data file for loading the data file into a database;
loading an output of the preparation into a database;
normalizing content and structure of the data in the database so that the content and structure fits preconditions to map;
mapping the content in the database to a standardized database layout; and
importing by applying the mapping through an automated process to get the content into a standardized database format.

6. The method of claim 1, wherein the level of roof enforcement is determined based on the number of roof permits compared with one or more of a total number of overall permits, population, or number of structures for each building department.

7. The method of claim 1, wherein analyzing the data to determine the one or more coverage areas comprises calculating a geographical footprint for each building department based upon information from building permits.

8. The method of claim 7, wherein the information from building permits comprises one or more of geospatial coordinates of structures, streets, census tracts, or block groups.

9. The method of claim 1, wherein the area average roof age is calculated based on one or more of tax assessor data, roof enforcement data, coverage area, or property-level roof replacement data.

10. The method of claim 1, wherein the area average roof age is calculated for geographic areas selected from one or more of the group consisting of zip5 code, city, county, zip3 code, Metropolitan Statistical Area, and state.

11. The method of claim 1, wherein the area average roof age is calculated based on a set of structures in the coverage area of building departments where the enforcement is at least Average.

12. The method of claim 1, wherein the area average roof age is calculated based on a set of structures built before the building permit data coverage starts through present.

13. The method of claim 1, wherein the average roof age for a given area is calculated by a weighted average of an average roof age for one set of structures and that of an older set of structures for the given area.

14. The method of claim 1, wherein a roof age confidence score is determined in addition to roof age.

15. The method of claim 14, wherein (i) if the target structure is within the coverage area, then confidence is scored as modeled; (ii) if the structure is within a coverage area and structure-level information on a roof replacement is available, then confidence is scored as high; (iii) if the target structure is within the coverage area but property-level information on a roof replacement is not available, then confidence (a) is scored as high if the roof enforcement is above average or well above average, or (b) is scored as medium if the roof enforcement is average, or (c) is scored as low if the roof enforcement is seldom/none.

16. The method of any claim 1, wherein an audit is performed to verify that the converted data is equivalent to the received data.

17. A computer-implemented method for estimating roof age of a structure, the method comprising:
identifying a target structure for which an estimated roof age is desired;
providing access to data relating to a plurality of structures;
analyzing the data to determine if a coverage area exists for a building department responsible for regulating the target structure; and
estimating roof age of the target structure as an age ranging between the age of the target structure and an age calculated from the earliest date of any data for a structure within the coverage area, if the target structure is in the coverage area; or
estimating roof age of the target structure as an area average roof age both for the smallest area in which the target structure is located and for which an area average roof age is available, if the target structure is not in the coverage area.

18. A computer-implemented method for determining roof age of a structure, the method comprising:
accessing a standardized database of roof age source information;
determining a level of roof enforcement for each area regulated by a building department based on evaluating information from one or more of a number of roof permits issued by the building department, the total number of permits issued by the building department, and the population and number of structures for the area;
calculating a geographical footprint of a coverage area for each building department based upon information from building permits, including one or more of geospatial coordinates of structures, streets, census tract, and block groups;
calculating an area average roof age for a plurality of geographical areas of different scope for those structures in the coverage area of building departments passing a roof-enforcement level threshold, wherein the area average roof age is calculated based on the weighted average of the average age of set of new properties and the average age of a set of older properties; and
determining roof age for a particular structure, wherein:
if structure-level information on roof replacements is available, the roof age is based upon the date of the most recent roof replacement;
if structure-level information on roof replacements is not available, but the structure is within the coverage area, then the roof age is a range comprising the age of the structure and the first date for which data is available within the coverage area; or
if the structure is not within the coverage area, then the roof age is an area average roof age for the smallest area that both contains the address of the structure for which the area average roof age is available.

19. The method of claim 18, wherein roof age confidence is calculated.

20. A method of underwriting, renewing, evaluating a claim for, or generating marketing leads for insurance policies, the method comprising:
obtaining an estimated roof age of a target structure according to claim 1; and
underwriting, renewing, evaluating a claim for, or generating marketing leads for an insurance policy based on the roof age obtained.
